(19) United States
(12) Patent Application Publication
(10) Pub. No.: US 2026/0356333 A1
(43) Pub. Date: Nov. 12, 2026

(54) METHOD FOR CONTROLLING AN ELECTRONICALLY PRESSURE CONTROLLED POWER BRAKE SYSTEM AND ELECTRONICALLY PRESSURE CONTROLLED POWER BRAKE SYSTEM

(71) Applicant: Robert Bosch GmbH, Stuttgart (DE)

(72) Inventors: Dirk Foerch, Neuenstadt/Stein (DE); Blerim Gashi, Heilbronn (DE); Frederic Heasley, Farmington, MI (US); Mike Huff, Plymouth, MI (US)

(21) Appl. No.: 19/653,377

(22) Filed: Apr. 21, 2026

(30) Foreign Application Priority Data
May 9, 2025 (DE) 10 2025 117 840.2

(51) Int. Cl. B60T 8/172; B60T 8/171; B60T 8/40; B60T 13/14; B60T 13/62; B60T 13/68; B60T 13/74

(52) U.S. Cl. CPC B60T 8/172; B60T 8/171; B60T 13/142; B60T 13/148; B60T 13/62; B60T 13/686; B60T 13/745; B60T 8/4081; B60T 2220/04; B60T 2270/402; B60T 2270/404; B60T 2270/406; B60T 2270/82

(57) ABSTRACT

A method for controlling an electronically pressure-controlled power brake system and an electronically pressure-controlled power brake system. The power brake system is monitored for faults of a second brake pressure generator; if necessary, the pressure level is reduced in the brake circuit to a pressure level that is lower than the pressure level in the master brake cylinder and the pressure medium connection is opened between the master brake cylinder and the brake circuit so that pressure medium flows from the master brake cylinder into the brake circuit.

### FIELD

The present disclosure relates to a method for controlling an electronically pressure-controlled power brake system and an electronically pressure-controlled power brake system. The electronically pressure-controlled power brake system on which the present disclosure is based are described in Germany Patent Application No. DE 10 2019 201 536A1 .

### BACKGROUND INFORMATION

Electronically pressure-controlled power brake systems differ fundamentally from conventional muscle-power brake systems in that, in the case of power brake systems, the driver is no longer involved in the build-up of brake pressure, but rather merely specifies a braking demand by the actuation of a pedal or lever. The actuation path covered by the pedal or lever is detected by a sensor and converted by an externally driven brake pressure generator into a brake pressure corresponding to the braking demand.

Power brake systems are particularly suitable for use in modern vehicles with fully electric or partially electric drives, where the braking torques of a vehicle drivetrain and of a vehicle brake system are superimposed during a braking operation. Apart from that, power brake systems are also suitable for vehicles equipped with electronic assistance systems that allow at least semi-autonomous driving and braking maneuvers. For example, power brake systems can be used to control the distance to a vehicle in front independently of the driver, or to automatically trigger a braking operation in dangerous situations.

The advantage of the aforementioned decoupling of the driver from the build-up of brake pressure is that the driver receives no haptic feedback from the power brake system, for example in the case of pressure changes in the brake system due to wheel slip control during anti-lock brake system (ABS) operation or during vehicle dynamics control (ESP mode).

To provide pedal feel to the driver, the power brake systems according to the present disclosure are equipped with a travel simulator. Said simulator allows the feedback to the driver to be largely freely selected according to customer or user requirements.

Furthermore, power brake systems improve driving comfort because, since the driver is decoupled from the system, vibrations caused by brake pressure generation are not transmitted via the pedal into the interior of a vehicle. Furthermore, power brake systems are independent of any vacuum provided by the vehicle drivetrain to perform brake boosting.

The power brake system described in Germany Patent Application No. DE 10 2019 201 536 A1 comprises, inter alia, a braking demand detection device, with a master brake cylinder that can be actuated by a driver and a travel simulator that can be electrically controlled and connected to the master brake cylinder. Furthermore, an electromechanically actuated first brake pressure generator is provided to supply brake pressure depending on a braking demand in a brake circuit with wheel brakes connected thereto. Parallel to the first brake pressure generator, a second brake pressure generator can be connected to the brake circuit and is also designed to be electromechanically actuated. The second brake pressure generator interacts with a valve unit of electrically controlled valves to provide individual wheel control of the brake pressure depending on the prevailing wheel slip at the wheels associated with the wheel brakes. An electrically controlled second valve assembly serves to control a pressure medium connection between the master brake cylinder and the brake circuit. Finally, an electronic control unit provides demand-based electrical control of the brake pressure generators or valve assemblies during a braking operation.

The first brake pressure generator, according to the related art, is a piston/cylinder unit with a plunger piston that is movably mounted in a plunger cylinder. To build up pressure, the plunger piston is actuated in one of two possible directions of movement, and to reduce pressure, it is actuated in a second direction of movement in the opposite direction. The plunger piston is actuated by an electric motor via an intermediate gearbox, wherein said gearbox converts a rotational movement of the electric motor into a linear movement of the plunger piston. Depending on the direction of actuation of the plunger piston, the volume of a working chamber enclosed between the plunger piston and the plunger cylinder decreases or increases, thereby displacing pressure medium contained in this working chamber toward the connected wheel brakes or pumping it back from the connected wheel brakes into the working chamber. Accordingly, the brake pressure in connected wheel brakes increases or decreases.

If, during a braking operation the wheel slip on at least one wheel is controlled by the conventional power brake system, pressure medium is released from the associated wheel brake by electrical control of an associated outlet valve, which leads to the plunger piston being moved further into the working chamber of the piston/cylinder unit by the electric motor in order to build up brake pressure again. This cyclical process can be repeated until the volume of pressure medium in the working chamber reaches a critical minimum level for brake pressure control during a subsequent braking operation. At the latest then, the working chamber must be refilled with new pressure medium from the pressure medium reservoir. This operation is achieved by driving the plunger piston in the pressure reduction direction while simultaneously shutting off the pressure medium connection between the first brake pressure generator and the brake circuit.

The structural design of a power brake system, particularly with regard to the dimensioning of the piston/cylinder unit of its first brake pressure generator, determines the number or frequency of so-called refilling cycles of the working chamber. The aim is to perform refilling cycles as infrequently as possible, because brake pressure control cannot take place during these refilling cycles. However, there are limits to the structural design of the piston/cylinder unit due to cost and space constraints.

Although the described power brake system operates extremely reliably, a fault cannot be ruled out in which and individual wheel pressure control is not available, e.g., because the second brake pressure generator required for this is out of service for mechanical or electrical reasons. In this case, the volume of pressure medium available for building up brake pressure in the wheel brakes is limited to the volume of pressure medium present in the working chamber of the first brake pressure generator.

### SUMMARY

The present disclosure relates to a method for controlling an electronically pressure-controlled power brake system, with which the ability of the first brake pressure generator to control brake pressure is extended or prolonged during such a fault. Through purely control-related measures, the provided method increases the volume of pressure medium available to the first brake pressure generator beyond the volume of pressure medium in its working chamber, without requiring any changes to the design or dimensioning of the existing components of the power brake system. The present disclosure extends the service life of a power brake system in the event of a fault and, due to the lack of additional components required, can be implemented cost-effectively and without requiring additional installation space.

According to an example embodiment of the present disclosure, it is provided that the power brake system is first monitored by the electronic control unit for possible faults of the second brake pressure generator. In the event of a fault, the first brake pressure generator is controlled by the electronic control unit in such a way that it preferentially reduces the brake pressure in one of the existing brake circuits to a pressure level that is lower than the pressure level generated by the driver in the decoupled master brake cylinder. During or after a reduction in brake pressure in the brake circuit, a circuit separation valve is then electrically controlled in such a way that the pressure medium connection from the master brake cylinder to the brake circuit is opened. Due to the existing pressure differential, pressure medium then flows from the master brake cylinder into the brake circuit without having to move the plunger piston of the first brake pressure generator. After the circuit separation valve has been actuated, the plunger piston is actuated for an extremely short time interval and thus over a correspondingly short piston travel, in order to raise the brake pressure in the brake circuit back to the original brake pressure level.

The method according to the present disclosure therefore runs cyclically and can be carried out multiple times by the electronic control unit until approximately the entire volume of pressure medium present in the master brake cylinder has been transferred into the brake circuit. The method is applied no later than when the volume of pressure medium in the working chamber of the first brake pressure generator has reached a minimum value that is critical for brake pressure control of a subsequent braking operation.

Advantageously, the provided method is only applicable if the driver has specified a definable minimum pressure level in the master brake cylinder.

Further advantages or advantageous developments of the present disclosure can be found herein.

### BRIEF DESCRIPTION OF THE DRAWINGS

The present disclosure is explained in more detail below with reference to the figures.

FIG. 1 shows the hydraulic circuit diagram of an electronically pressure-controlled power brake system on which the present disclosure is based.

FIG. 2 illustrates an example method according to the present disclosure using a flowchart.

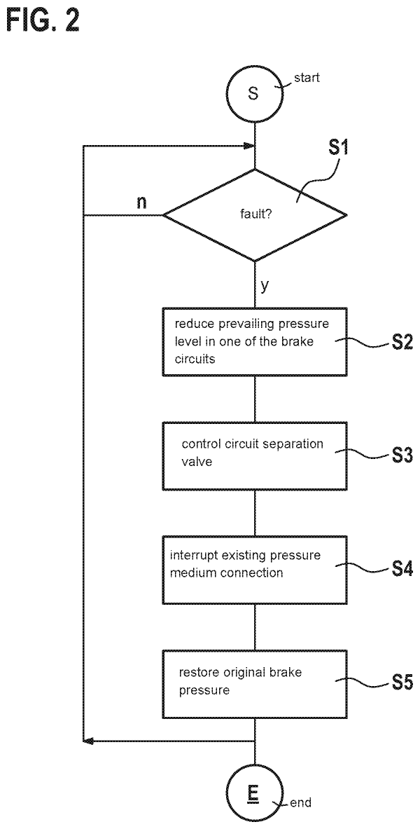

### DETAILED DESCRIPTION OF EXAMPLE EMBODIMENTS

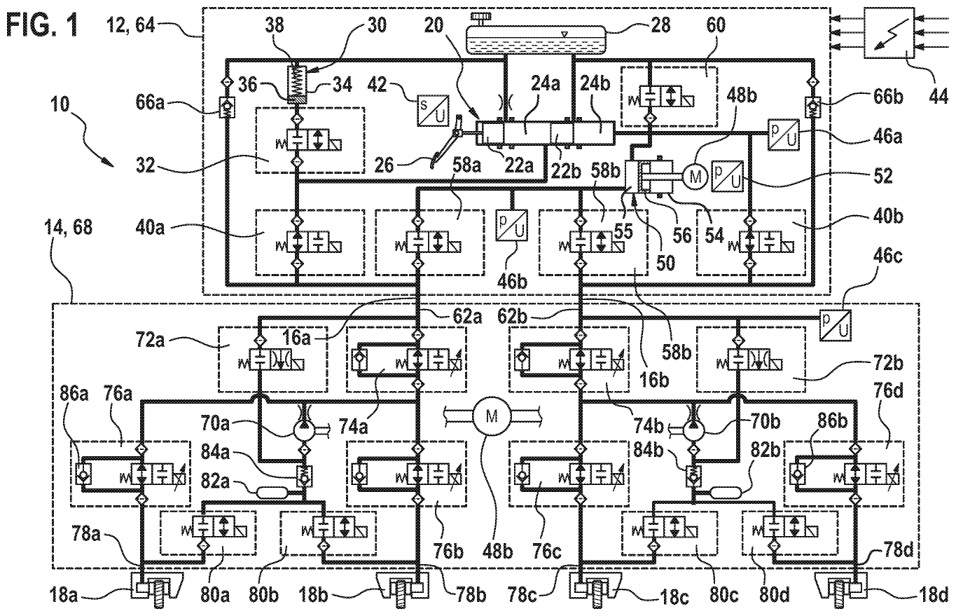

FIG. 1 shows the hydraulic circuit diagram of an electronically pressure-controlled power brake system, which consists of a total of two hydraulically coupled brake units (12; 14). These can be installed separately from one another in the body of a motor vehicle, wherein the first brake unit (12) is generally attached to a firewall of the vehicle body to allow its actuation by the driver.

The first brake unit (12) serves to detect braking demands and to provide brake pressure in two separate brake circuits (16a; b), while the second brake unit (14) serves to individually control the brake pressure in wheel brakes (18a-d), which are connected to the second brake unit (14) via pressure medium lines. The individual wheel brake pressure control is carried out depending on a wheel slip occurring at at least one of the wheels associated with the wheel brakes (18a-d). In the exemplary embodiment, a total of four wheel brakes are connected in pairs to one of the two brake circuits (16a; b).

For braking demand detection, the first brake unit (12) has a master brake cylinder (20) that can be actuated by the driver. In the exemplary embodiment, it is designed as a tandem master brake cylinder with two master cylinder pistons (22a; b), namely a rod piston and a floating piston, and two master cylinder chambers (24a; b) bounded by these master cylinder pistons. The master brake cylinder (20) can be actuated via a pedal (26), although an actuating lever could also be possible as an alternative to this pedal. The master brake cylinder (20) is supplied with pressure medium via a pressure medium reservoir (28) of the power brake system (10), which reservoir is hydraulically connected to the master brake cylinder (20).

The pedal-side master cylinder chamber (24a) is hydraulically connected to an input side of a travel simulator (30), with a pressure medium connection provided for this purpose being controlled by a simulator control valve (32). This simulator control valve (32) is a valve that is closed in its home position and releases the pressure medium connection to the travel simulator (30) by electrical control.

Incoming pressure medium deflects a simulator piston (36) arranged in a simulator housing (34) against the force of a simulator piston return spring (38).

The master cylinder chambers (24a; b) of the master brake cylinder (20) are each controllable via a so-called circuit separation valve (40a; b) connected to one of the two brake circuits (16a; b). The circuit separation valves (40a; b) are normally open valves that can be switched to a closed position by electrical control. In the closed position of these circuit separation valves (40a; b), no pressure medium can be displaced into the brake circuits (16a; b) by actuation of the master brake cylinder (20), so that the master brake cylinder (20) is, in other words, hydraulically decoupled from these brake circuits (16a; b). This is the case when the power brake system (10) is in normal operating mode.

The creation of an actuation path of the pedal (26) therefore requires an open simulator control valve (32) so that pressure medium can be displaced from the pedal-side master cylinder chamber (24a) to the travel simulator (30).

The actuation path of the pedal (26) is detected by a pedal travel sensor (42) and transmitted in the form of an electrical sensor signal to an electronic control unit (44) of the power brake system (10). This pedal travel represents a braking demand from the driver and ultimately correlates with a brake pressure to be set in the wheel brakes (18a-d). A first pressure sensor (46a) is provided in the pressure medium connection from the master cylinder chamber (24b) facing away from the pedal to the associated circuit separation valve (40b). Said pressure sensor detects the master cylinder chamber pressure generated by the driver in the associated master cylinder chamber (24b) and forwards a corresponding electrical sensor signal to the electronic control unit (44) for further processing or to verify the plausibility of an ongoing brake pressure generation.

To provide this brake pressure, the first brake unit (12) is equipped with a first brake pressure generator (50) which can be driven by a first electric motor (48a). That electric motor (48a) is controlled by the electronic control unit (44) with an electrical control signal that depends on the detected pedal travel. A rotating drive movement of the electric motor (48a) is detected by a rotation angle sensor (52), the rotation angle signal of which is also evaluated by the electronic control unit (44). The rotational movement of the first electric motor (48a) is converted into a linear movement by a downstream mechanical gearbox (not visible in FIG. 1), by means of which a plunger piston (56) of the first brake pressure generator (50), which is movably arranged in a plunger cylinder (54), is driven. The plunger piston (56) displaces pressure medium from a working chamber (55) of the plunger cylinder (54) into a line connection from which the two brake circuits (16a; b) branch off. The pressure level prevailing in this line connection is detected by means of a second pressure sensor (46b), the signal of which is also evaluated by the electronic control unit (44).

The connections of the first brake pressure generator (50) to the brake circuits (16a; b) can be controlled separately by means of plunger control valves (58a; b). The plunger control valves (58a; b) are designed as switching valves, which, in an electrically uncontrolled home position, block the respective connections and thus decouple the first brake pressure generator (50) from the brake circuits (16a; b). The plunger cylinder (54) is supplied with pressure medium from the pressure medium reservoir (28) via a supply line, which can be controlled by a normally closed plunger supply valve (60).

The two brake circuits (16a; b) of the power brake system (10) terminate at associated first brake circuit connections (62a; b), which are formed on a first housing block (64) of the first brake unit (12). Each pressure medium channel formed in this first housing block (64) connects one of the brake circuit connections (62a; b) to the associated plunger control valve (58a; b), to the associated circuit separation valve (40a; b) and to the pressure medium reservoir (28). Immediately downstream of the pressure medium reservoir (28), a first check valve (66a) is provided in the pressure medium channel which check valve permits flow in a flow direction from the pressure medium reservoir (28) to the brake circuit connection (62a; b) and blocks flow in the opposite direction.

The first brake circuit connections (62a) of the first brake unit (12) are connected via pressure medium lines to second brake circuit connections (62b) on a second housing block (68) of the second brake unit (14).

The second brake unit (14) is equipped with a second brake pressure generator (70a; b) for each brake circuit (16a; b) and a second electric motor (48b), which jointly drives these two second brake pressure generators (70a; b). The second brake pressure generators (70a; b) are connected in parallel with the first brake pressure generator (50) to each of the brake circuits (16a; b). For this purpose, the second brake pressure generators (70a; b) are connected on the suction side via an associated electrically controlled high-pressure switching valve (72a; b) to each of the second brake circuit connections (62b) and on the pressure side via an equally controlled pressure control valve (74a; b) to the brake circuit connection (62b) on the one hand, and via an electrically controlled inlet valve (76a-d) to one of a total of four wheel brake connections (78a-d) formed on the second brake unit (14) on the other hand. Downstream of each wheel brake connection (78a-d) there is in each case an electrically controlled outlet valve (80a-d) via which pressure medium can be released, if necessary, from a connected wheel brake into a brake-circuit-specific accumulator (82a; b) in the course of an active individual wheel brake pressure control process. Each of the two accumulators (82a; b) is in turn connected to the suction side of the second brake pressure generator (70a; b) via an accumulator check valve (84a; b). This accumulator check valve (84a; b) prevents the return of pressure medium from one of the two second brake pressure generators (70a; b) back into the associated accumulator (82a; b).

Finally, each inlet valve (76a-d) is connected in parallel to an inlet check valve (86a-d). This inlet check valve (86a-d) allows pressure medium to flow from the associated wheel brake (18a-d) toward the pressure side of the second brake pressure generator (70a; b) and blocks the opposite direction. The pressure control valves (74a; b) and the inlet valves (76a-d) of the second brake unit (14) are normally open valves, while the high pressure switching valves (72a; b) and the outlet valves (80a-d) are normally closed.

The brake circuit (16a; b) of the second brake unit (14) which is connected in the first brake unit (12) to the master cylinder chamber (24b) remote from the pedal of the master brake cylinder (20) is equipped with a third pressure sensor (46c). Based on the signal from this third pressure sensor (46c), the electronic control unit (44) can monitor the brake pressure build-up or the supply of pressure medium to this brake circuit (16b) by the first brake pressure generator (50).

As mentioned at the outset, a braking demand is specified by a driver by actuating the master brake cylinder (20) in the first brake unit (12). The pedal travel resulting from the actuation of the master brake cylinder (20) is detected by sensors and further processed by the electronic control unit (44) into a control signal to the electric motor (48a) of the first brake pressure generator (50). This electric motor (48a) then drives the plunger piston (56) of this first brake pressure generator (50), which in turn displaces pressure medium from a working chamber (55) to the wheel brakes (18a-d). In these wheel brakes (18a-d) a brake pressure corresponding to the pedal travel then builds up. The master brake cylinder (20), and thus also the driver, are decoupled from the brake circuit (16a; b) or from the brake pressure generation via the closed circuit separation valves (40).

In the event of slippage occurring on one of the wheels associated with the wheel brakes (18a-d), the second brake unit (14) is activated to reduce the brake pressure of the affected wheel as required. For this purpose, the inlet valve (76a-d) associated with the wheel brake (18a-d) is closed by electrical control and the associated outlet valve (80a-d) is opened. In parallel, at least the second brake pressure generator (70a; b) is actuated to reduce the brake pressure in the affected wheel brakes (18a-d) until the rotational speed of the slipping wheel corresponds to the vehicle speed again.

If a fault occurs at the second brake pressure generator (14), for example due to a mechanical or electrical defect, the volume of pressure medium in the working chamber (55) of the first brake pressure generator (50) may not be sufficient to set a brake pressure corresponding to the braking demand.

The present disclosure therefore provides the method explained in detail below, by which an additional volume of pressure medium is made available to the first brake pressure generator (50) after a fault has been detected in the second brake pressure generator (70a; b). By providing an additional volume of pressure medium, the period within which the first brake pressure generator (50) is able to maintain a brake pressure boost is extended.

The present disclosure provides, in a method step S1, for electronically monitoring the power brake system (10) with regard to the functionality of the second brake pressure generator (70a; b). For this purpose, the electronic control unit (44) is used, which verifies the plausibility of the already existing signals of the three pressure sensors (46a-c) of the brake units (12; 14), the actuation signal of the pedal travel sensor (42) and the rotation angle signal of the rotation angle sensor (52) against the electrical signals from or to the electric motor (48b) of the second brake pressure generator (70a; b). If this plausibility check reveals a fault, then in step $2 the prevailing pressure level in one of the brake circuits (16a; b) is preferably reduced by appropriate electrical control of the first brake pressure generator (50) to a value which is lower than the pressure level generated by the driver in the master brake cylinder (20).

In step S3, the circuit separation valve (40a; b) associated with the brake circuit (16a, b) is controlled by the electronic control unit (44) for a limited period of time such that this circuit separation valve (40a; b) releases the previously interrupted pressure medium connection between the master cylinder chamber (24a; b) of the master brake cylinder (20) and the associated brake circuit (16a; b). With the opening of this pressure medium connection, pressure medium flows from the associated master cylinder chamber (24a; b) into the associated brake circuit (16a; b) due to the existing pressure differential.

After the valve actuation period has elapsed, in step S4 the existing pressure medium connection is interrupted again and in step S5 the original brake pressure in the brake circuit (16; b) is restored by actuating the first brake pressure generator (50). To do this, the plunger piston (56) of the first brake pressure generator (50) must be moved only a little further into the working chamber (55) of the plunger cylinder (54) by the first electric motor (48a).

The described method is carried out no later than when the pressure medium volume in the working chamber (55) of the plunger cylinder (54) has dropped to a definable minimum value which is no longer sufficient for electronic brake pressure control of a subsequent braking operation. The described method can be repeated multiple times until the pressure medium present in the master cylinder chamber (24a; b) has been reduced to at least near zero.

Of course, changes or additions to the described method according to the present disclosure or to power brake system according to the present disclosure are possible without thereby departing from the scope of protection covered by the present disclosure.

1-6. (canceled)

7. A method for controlling an electronically pressure-controlled power brake system, the power brake system including:
a braking demand detection device including a driver-actuated master brake cylinder and a travel simulator controllably connected to the master brake cylinder,
a first brake pressure generator actuated by an electrically controlled first electric motor to supply brake pressure depending on a braking demand in a brake circuit with wheel brakes connected thereto,
a second brake pressure generator which can be connected to the brake circuit in parallel with the first brake pressure generator and actuated by an electrically controlled second electric motor and which interacts with a unit of electrically controlled valves to provide individual wheel control of the brake pressure in the wheel brakes,
an electrically controlled circuit separation valve for controlling a pressure medium connection between the master brake cylinder and the brake circuit, and
an electronic control unit for demand-adapted electrical control of the electric motors and valves;
the method comprising the following steps:
monitoring the power brake system by the electronic control unit for possible faults of the second brake pressure generator;
based on detecting a fault during the monitoring, reducing the brake pressure in the brake circuit by actuating the first brake pressure generator to a pressure level which is lower than a prevailing pressure level in the master brake cylinder; and
during or after the reducing of the brake pressure in the brake circuit, electrically actuating the circuit separation valve in such a way that the pressure medium connection from a master cylinder chamber of the master brake cylinder to the brake circuit is opened, so that, due to an existing pressure differential, pressure medium flows from the master cylinder chamber into the brake circuit.

8. The method according to claim 7, wherein the electrical control of the circuit separation valve by the electronic control unit is carried out for a limited period of time, and following the limited period of time, the first brake pressure generator is actuated to raise the brake pressure in the brake circuit to an originally prevailing pressure level.

9. The method according to claim 7, wherein carrying out the method requires a definable minimum pressure present in a master cylinder chamber of the master brake cylinder.

10. The method according to claim 7, wherein the method is carried out after a volume of pressure medium in a working chamber of the first brake pressure generator has reached a definable minimum value.

11. The method according to claim 7, wherein the method is carried out a number of times until a volume of pressure medium in a master cylinder chamber of the master brake cylinder has reached a definable minimum value.

12. An electronically pressure-controlled power brake system, comprising:
a first brake unit; and
a second brake unit that can be arranged separately from the first brake unit and can be hydraulically connected to the first brake unit;
wherein the first brake unit includes a braking demand detection device including a driver-actuated master brake cylinder, a travel simulator, and a first brake pressure generator that can be actuated by an electrically controlled first electric motor for generating brake pressure in a brake circuit with wheel brakes connected thereto,
wherein the second brake unit includes a second brake pressure generator which can be actuated by an electrically controlled second electric motor and which can be connected to the brake circuit in parallel with the first brake pressure generator, and
wherein the second brake pressure generator interacts with a unit of electrically controlled valves to provide individual wheel control of the brake pressure in the wheel brakes;
wherein the power brake system further comprises an electrically controlled circuit separation valve for controlling a pressure medium connection between the master brake cylinder and the brake circuit;
wherein the power brake system further comprises an electronic control unit configured to:
monitor the power brake system for possible faults of the second brake pressure generator;
based on detecting a fault during the monitoring, reduce the brake pressure in the brake circuit by actuating the first brake pressure generator to a pressure level which is lower than a prevailing pressure level in the master brake cylinder, and
during or after the reduction of the brake pressure in the brake circuit, electrically actuate the circuit separation valve in such a way that the pressure medium connection from a master cylinder chamber of the master brake cylinder to the brake circuit is opened, so that, due to an existing pressure differential, pressure medium flows from the master cylinder chamber into the brake circuit.
